(19) United States
(12) Patent Application Publication
(10) Pub. No.: US 2006/0170705 A1
(43) Pub. Date: Aug. 3, 2006

(54) Method and system to review the display of content

(75) Inventor: Robb Wilson, Loveland, CO (US)

Correspondence Address: SCHWEGMAN, LUNDBERG, WOESSNER & KLUTH, P.A., P.O. BOX 2938, MINNEAPOLIS, MN, 55402, US

(73) Assignee: Lyris Technologies, Inc.

(21) Appl. No.: 11/048,956

(22) Filed: Feb. 1, 2005

(51) Int. Cl. G09G 5/00

(52) U.S. Cl. 345/628

(57) ABSTRACT

A system and method is provided to review the display of content by at least one client application. The method may include communicating content to client applications and automatically simulating user interaction with the client application in response to receiving the content. Thereafter, an image displayed by the client application may be captured in response to the simulated user interactions and stored. In an embodiment, the client application is email client and the content is communicated in an email. The invention extends to a system and method of reviewing content sent to a plurality of client applications. Accordingly, the method may include accessing a plurality of captured images displayed by the plurality of client applications and providing a graphical user interface. The graphical user interface may render client application and captured image display areas. Navigation buttons may be provided to allow a user to navigate through the captured images.

### TECHNICAL FIELD

The present application relates generally to the technical field of reviewing the display of content and, in one example, to reviewing the display of content of an email message for display on an email client.

### BACKGROUND

Electronic communications are becoming increasingly popular in replacing traditional paper communication. Such communications are not only more favorable due to the speed and ease of an electronic communication, but also due to the ability to include multimedia enhancements. In traditional communications, a printed document is sent to a user and the sender thus has total control of what a recipient views. However, an electronic communication requires a display application for the recipient to view the content of the communication. One of the primary communication networks for sending electronic communications is the Internet.

A well known example of an electronic communication is an email message (email) and, in order to view or “open” the email, a recipient requires an email client or application. Many companies have developed various software tools for users to communicate and view email. Such software tools or applications are typically known as email clients and examples include Microsoft Outlook, Yahoo email client, MSN email client, AOL email client, Eudora email client, Lotus Notes, etc.

However, the visual rendering or display of content sent or received via the email client is thus dependent upon the particular email client used. Thus, communications to a particular user utilizing an email client may vary from email client to email client. As not all email clients are identical, the visual rendering of instructions to the email client may differ from email client to email client and, accordingly, the actual display or visual rendering of the content to the user may vary.

### SUMMARY

According to one exemplary embodiment, there is provided a method and system to review the display of content for distribution via a communication network.

According to another exemplary embodiment, there is provided a method and system to review captured images displayed on a display client.

The invention extends to a machine-readable medium embodying instructions which, when executed by a machine, cause the machine to perform any one or more of the methodologies described herein.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 shows a system, in accordance with the invention, to review the display of content distributed to users via a network;

FIG. 2 shows exemplary hardware components of the system of FIG. 1;

FIG. 3 shows a flow diagram of a method, in accordance with the invention, to review the display of content by at least one email client;

FIG. 4 shows a method, in accordance with the invention, of functionality performed at an email gateway;

FIG. 5 shows a method, in accordance with the invention, to review the display of content at an agent desktop;

FIG. 6 shows an exemplary graphic user interface to allow a user to preview content displayed by a specific email client;

FIG. 7 shows an exemplary report generated in response to user interactions via the graphical user interface of FIG. 6;

FIG. 8 shows an exemplary method, in accordance with the invention, of reviewing an email sent to a plurality of email clients;

FIG. 9 shows an exemplary embodiment of a method to review the display of content by a plurality of email clients;

FIG. 10 shows an exemplary embodiment of a method, in accordance with the invention, for previewing an email sent to a plurality of email clients:

FIG. 11 shows an exemplary system, in accordance with the invention, to review the display of content by a plurality of email clients;

FIG. 12 shows an exemplary system, in accordance with the invention, to review images captured in response to an email sent to a plurality of email clients; and

FIG. 13 shows an exemplary machine in the form of a computer system for performing any one or more of the methodologies described herein.

### DETAILED DESCRIPTION

A method and system are described to review the display of content by at least one email client and to review images captured in response to the email sent to the plurality of clients. In the following description, for purposes of explanation, numerous specific details are set forth in order to provide a thorough understanding of the present invention. It will be evident, however, to one skilled in the art that the present invention may be practiced without these specific details. Further, although the exemplary embodiments are described with respect to content provided in an email sent to one or more email clients, it will be appreciated that the invention applies in any environment where content is distributed or sent electronically to a plurality of display applications that visually render the content to a user or recipient.

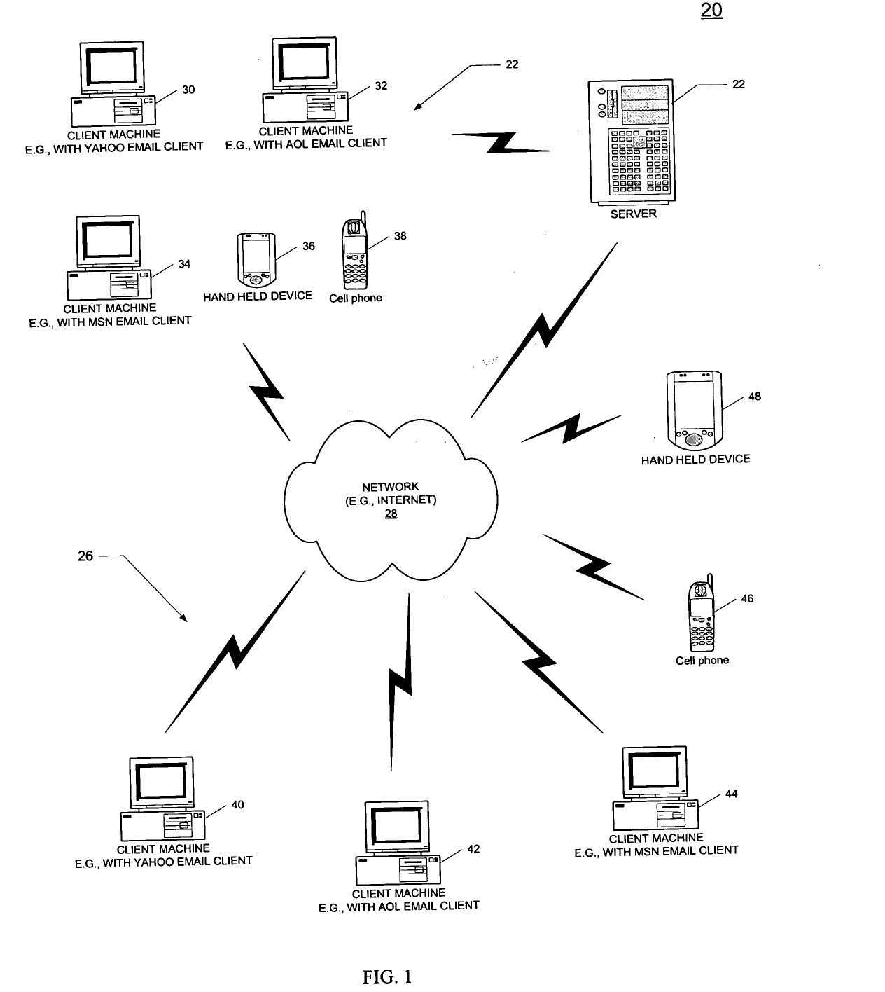

Referring to FIG. 1 of the drawings, reference 20 generally indicates a system, in accordance with the invention, to review the display or visual rendering of content by a plurality of display applications in the exemplary form of email clients. The system 20 allows a content creator to view the content of an email message as it would be displayed by a plurality of different email clients prior to communicating (e.g., bulk mailing) the content to the intended recipients or users. In one exemplary embodiment, a test email is sent to a plurality of different email clients each of which is provided on a separate client machine. However, it is to be appreciated, that the plurality of a different email clients (display applications) may be run on one or more client machines.

In the exemplary system 20, users can send a single test email with the content they intend to subsequently communicate to recipient users (e.g. via bulk emailing) to a single email address at a gateway server and review the content of the test email as displayed by the plurality of email clients. If necessary, the email message may then be edited so that its content is displayed appropriately on selected number (or all) of the email clients. Once a creator of the email is satisfied with the way in which it is displayed on the plurality of email clients, it is then sent to the actual intended recipients.

The system 20 is shown to include a server 22, a plurality of test client machines 24, and a plurality of user client machines 26. The user client machines 26, test client machines 24, and the server 22 communicate with each other via a network (e.g. the Internet) 28. In the exemplary embodiment, the test client machines 24 include a personal computer 30 running a Yahoo email client, a personal computer 32 running an AOL email client, a personal computer 34 running a MSN email client, a handheld device 36 (e.g. a PDA or the like) running an appropriate email client, and a cell phone 38 (e.g. a smart phone) running an appropriate email client. It is to be appreciated that the client machines 24 are merely examples of client machines and that further or other client machines may be provided in other embodiments. As described in more detail below, a user may compose a single email and communicate the email as a test email to the test client machines 24. User interactions with the test client machines 24 are automatically simulate and an image generated for display by each test client machine 24, after each simulated or mimicked user action, is captured and thereafter communicated to the server 22 for review by the sender of the email. Once the sender of the email is satisfied that the content of the email is correctly displayed by the test client machines 24, the email may then be subsequently communicated to the user client machines 26 for viewing by the intended recipients. In the exemplary embodiment shown in the drawings, the user client machines 26 correspond to the test client machines 24. Thus, the user client machines 26 are shown to include a user client machine 40 with a Yahoo email client, a user client machine 42 with an AOL email client, a user client machine 44 with a MSN email client, a user client machine in the form of a cell phone 46 with an appropriate email client, and a user client machine in the form of a handheld device 48 with an appropriate email client. It will however be appreciated that any other display devices or client devices e.g. a set top box or the like may also be included within the system 20 and that any number of different email clients may be included (e.g., Eudora, Lotus Notes etc.).

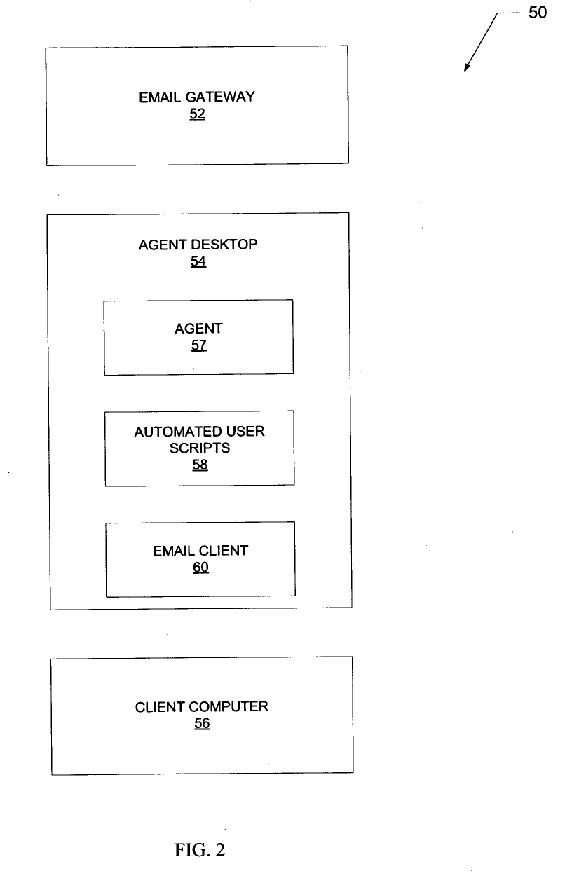

Referring to FIG. 2, reference 50 generally indicates exemplary details of various computers that may form of the system 20. The computers 50 are shown to include an email gateway 52 (which may correspond with the server 22), an agent desktop 54 (which may correspond with the test client machines 24), and a client computer 56 (which may correspond with the a client machine 56). The email gateway 52, agent desktop 54, and client computer 56 may be communicate via the Internet. In one exemplary embodiment, a user at the client computer 56 may communicate a test email including content for subsequent communication to a plurality of users via bulk emailing. The test email may be sent from the client computer 56 to the email gateway 52 which, in one exemplary embodiment, logs all incoming emails and forwards them to an appropriate account (or accounts) which a particular client computer has established with the system 20. Further, the email gateway 52 may track results generated by the system 20. As described in more detail below, the email gateway 52 may then communicate the test email received from the client computer 56 to the agent desktop 54 to perform analysis of the display or visual rendering of the email content on various different email clients.

The agent desktop 54 may act as an automated user and capture images generated after each user interaction. In one exemplary embodiment, the agent desktop 54 includes an agent 57, automated user scripts 58, and a specific email client 60. As mentioned above, in one exemplary embodiment, the agent desktop 54 runs a particular email client 60. For example, the email client on one agent desktop 54 may be Outlook, the email client 60 on another agent desktop 54 may be MSN email client, and so on. The agent 57 may manage a script running on the client machine and be responsible for communication with the email gateway 52. The automated user scripts 58 may be individual automated scripts that replicate, mimic or simulate user interaction with the particular email client 60. Accordingly, in order to review and capture images generated by the agent desktop 56, no user interaction is required and the agent desktop 54 automatically captures images generated by the email client 60 in response to an email received from the email gateway 52.

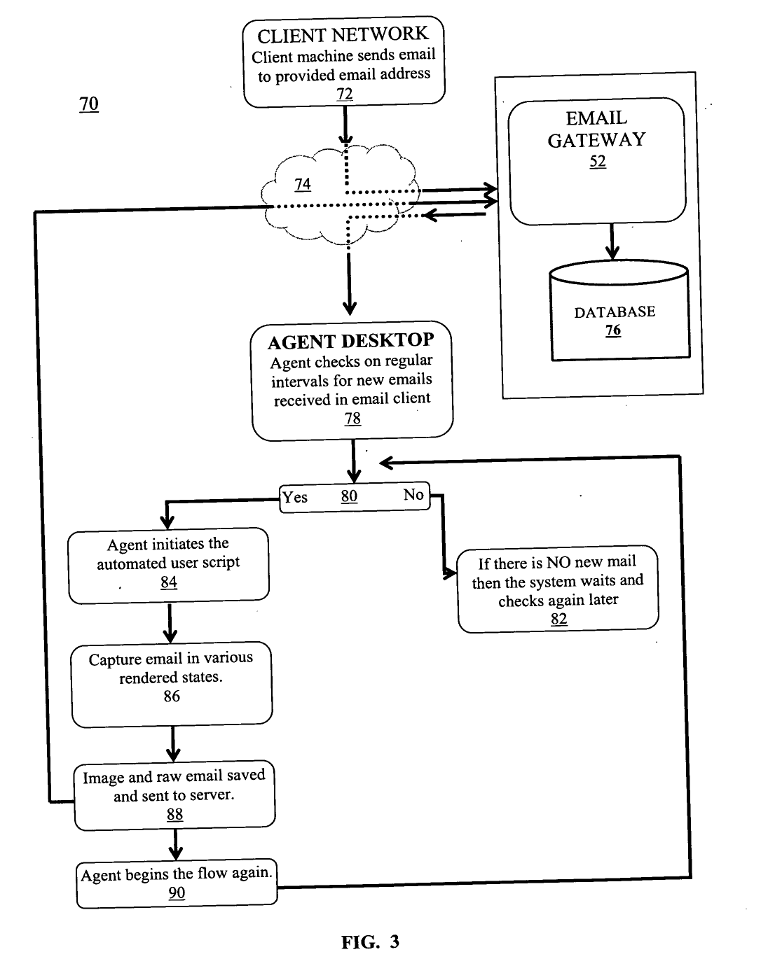

FIG. 3 shows an exemplary method 70, in accordance with the invention, to review the display of content by a plurality of email clients or applications. As shown at operation 72, a client machine (e.g. the client computer 56) sends an email to a specific email address (e.g., provided by the system 20). For example, the email is typically a test email message which is sent via the Internet 74 to an email gateway (e.g. the email gateway 52) where the email is then distributed to multiple accounts and stored in a database 76.

In order to review the display of content included in the test email on multiple email clients or applications, the email gateway 52 then forwards the test email to the plurality of test client machines (e.g. the test client machines 30, 32, 34, 36 and 38 or agent desktop 54). An agent (e.g., the agent 58) on each test client machine (e.g. the agent desktop 54) may check (e.g., at regular intervals) for any new email that may have been received by the specific email client (e.g. the email client 60) running on the agent desktop 54 (see operation 78). As shown at decision operation 80, the method 70 waits until a new email is received (see operation 82). Upon receipt of a new email by the agent desktop, then as shown at operation 84 the agent may initiate an automated user script (e.g. the automated user script 58) that simulates or user interaction. Thereafter, after each simulated user interaction performed by the user scripts 58, images are captured of any display rendered in response to the simulated user interaction (see operation 86). Thereafter, as shown at operation 88, each captured image and test email is saved and sent to a central server (e.g. a server at the email gateway 52). As shown at operation 90, once a particular test email has been processed, the method 70 returns to decision operation 80 to determine whether or not a further or new test email has been received for processing.

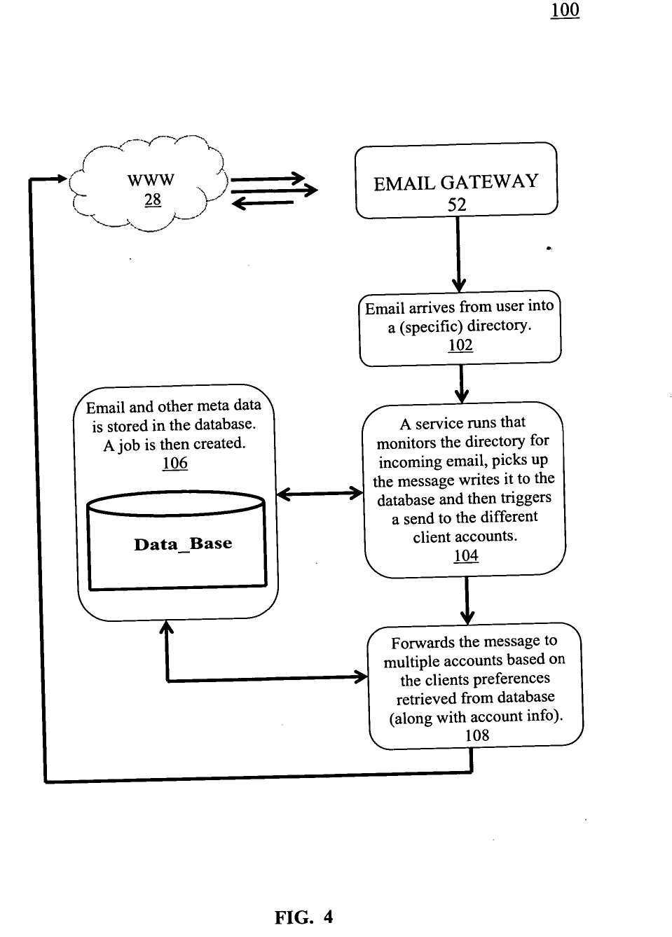

FIG. 4 shows an exemplary method 100, in accordance with an embodiment of the invention, to process a test email at an email gateway (e.g. the email gateway 52). As shown at operation 102, when a test email is received from a specific user it may then be saved into a specific directory. Thereafter, as shown at operation 104, the email gateway may include a service that runs and monitors a directory for incoming mail. The service or application may then identify that a test email message has been received. The message may then be written to a database (e.g. the database 76). In one exemplary embodiment, as shown at operation 106, any other metadata associated with the email may be stored in the database 76 and a job may then be created. The job created may thus be a job to review the display of content by the test email on various different email clients. As shown at operation 108, the email gateway may then communicate copies of the test email to multiple accounts based on client preferences. The client preferences may be stored in the database 76 and include client information, e.g., account information or the like. Thereafter, as described in more detail below, the test email may then be communicated to various test client machines (e.g. the test client machines 24) each running a different email client or application.

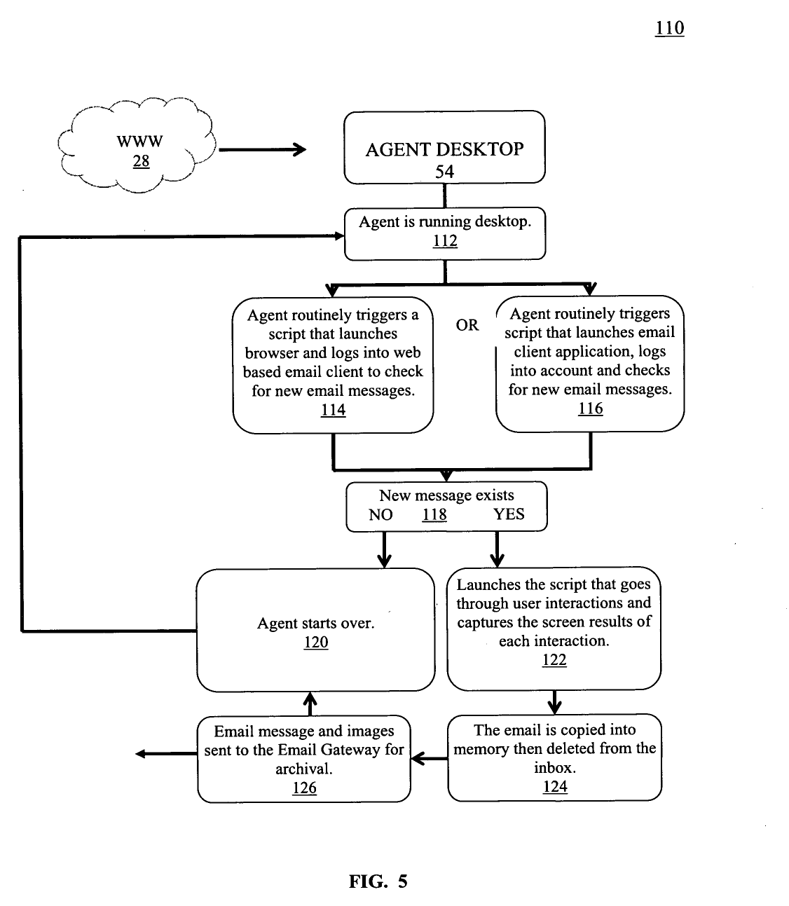

Referring in particular to FIG. 5, reference 110 generally indicates a method, in accordance with an embodiment of the invention, for automatically capturing images generated in response to simulated user interaction. As mentioned above, a test email may be received at an agent desktop e.g. the agent desktop 54 via a network 28 (e.g. the Internet). The method 110 includes running an agent (e.g. the agent 57) running on the agent desktop 54 (see operation 112). In one exemplary embodiment, the method 110 includes running a script at operation 112 which simulates or mimics a user's interaction with the email client (e.g. the email client 60). In one exemplary embodiment, as shown at operation 114, the agent may routinely trigger a script that launches a browser and logs into a web based email client (e.g., a Yahoo email client, an MSN email client, an AOL email client or the like) to check for new email messages. Instead, the agent may routinely trigger a script that launches the email client application logs into a specific account (e.g., a Microsoft Outlook email client or the like) and checks for new email messages as shown at operation 116.

Thereafter, as shown at decision operation 118, the method checks to determine whether or not a new email message exists or has arrived. As shown at operation 120, if a new email message has not arrived, the method 110 returns to operation 112. If, however, a new email message has been received, the method 110 launches the script that simulates or mimics various appropriate user interactions and captures the screen results after each interaction (see operation 122). It will, however, be appreciated that the image generated after the simulated user interactions need not actually be displayed on the monitor but the image or screen shot rendered for display on the monitor may be captured. For example, display output from a particular email client may be captured and stored.

Once the various screen shots or images to be rendered have been captured, the test email may then be copied into persistent memory at the agent desktop 54 and the test email may be deleted from an inbox of the email client running on the agent desktop 54. In one exemplary embodiment, the email message as well as the captured images are then sent to an email gateway (e.g. the email gateway 52) where they are stored (see operation 126). Thereafter, the method 110 may return to operation 112 and await a further test email for processing.

As discussed above by way of example, the system 20 and the methods 70, 100 and 110 allow a user to send a test email to an email gateway which may then distribute the email to a plurality of different client machines each of which runs a specific or selected email client or application. In an automated fashion, and without user interaction, an agent desktop simulates user interaction with the email client and captures an image generated in response to each user interaction. The captured images may then be communicated to a central point such as the email gateway 52 or the server 22. The plurality of captured images received at the email gateway 52 or the server 22 may then be reviewed or analyzed by a user (e.g. the user originally sending the test email) to determine whether or not the content requires rearranging/modification so that it is suitably or appropriately displayed on all email clients or at least a substantial number of email clients and not merely on a single email client. A user may thus tailor the content so that its display on multiple email clients is optimized or at least enhanced.

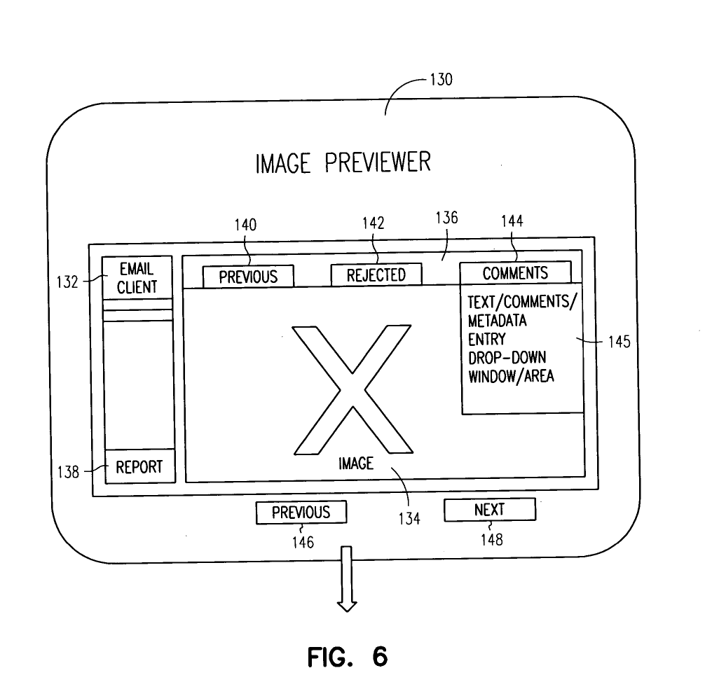

Referring to FIGS. 6-8 of the drawings, reference 130 in FIG. 6 generally indicates a graphical user interface (GUI) of an image previewer to allow a user to review how an email sent to the plurality of different email clients is displayed on each different email client. The GUI 130 is shown to include an email client display area 132, an image display area 134 for viewing captured images, navigation buttons 136, and a report button 138. The email client display area 132 may provide a list of emails clients and images captured from each email client that are available for viewing or processing. When a captured is selected by a user, it is then displayed in the image display area 134. In an exemplary embodiment, the stored images are first ordered or grouped in the email client display area 132 by email client and thereafter, for example, by a type of view within each client when multiple views are available. Thus, using a single graphical user interface, a user may preview images captured from the plurality of different email clients generated in response to receipt of a single test email.

In order to allow a user to process each captured image, the navigation buttons 136 include an Approved button 140, a Rejected button 142, and a Comments button 144. The Approved button 140 may be activated by the user if the captured image displayed in the image display area 134 is acceptable. If, however, the captured image is not acceptable, the user may activate the Rejected button 142. In addition, upon activation of the Comments button 144, a user may enter metadata or comments relevant to the particular captured image being viewed. For example, a text/comments/metadata entry drop-down window or area 145 may be generated. The user may then enter/type text associated with an image being viewed. Comments and any metadata may then be stored for subsequent review and/or for printing in a report. Previous and Next buttons 146 and 148 are provided to allow a user review a previous image or proceed to the next image in a list. Upon activation of the report button 138, a report may be generated as described in more detail below.

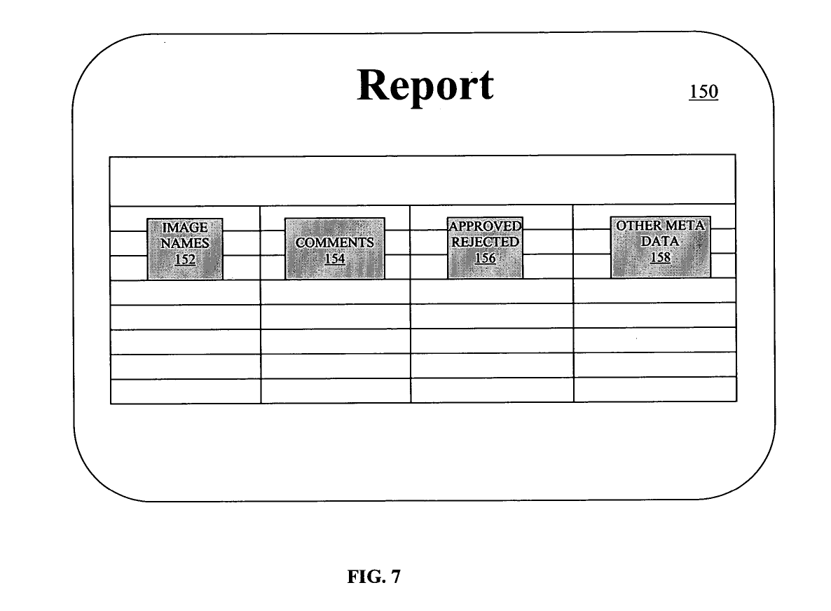

FIG. 7 shows an exemplary report 150 that may be generated in response to a user processing the captured images using the graphical user interface 130. In one exemplary embodiment, the report 150 allows a user to archive, share and review information associated with each email client or image. In the illustrated embodiment, the report 150 is in the form of a table including a column 152 for image names, a column 154 for comments entered by the user upon activation of the Comments button 144, a column 156 that indicates whether or not a particular captured image is approved or rejected, and a column 158 for any other metadata that may be associated with each captured image listed in column 152. Thus, the report 150 may assist a user in deciding whether or not the configuration or arrangement of content in a test email is appropriate for display on the plurality of email clients.

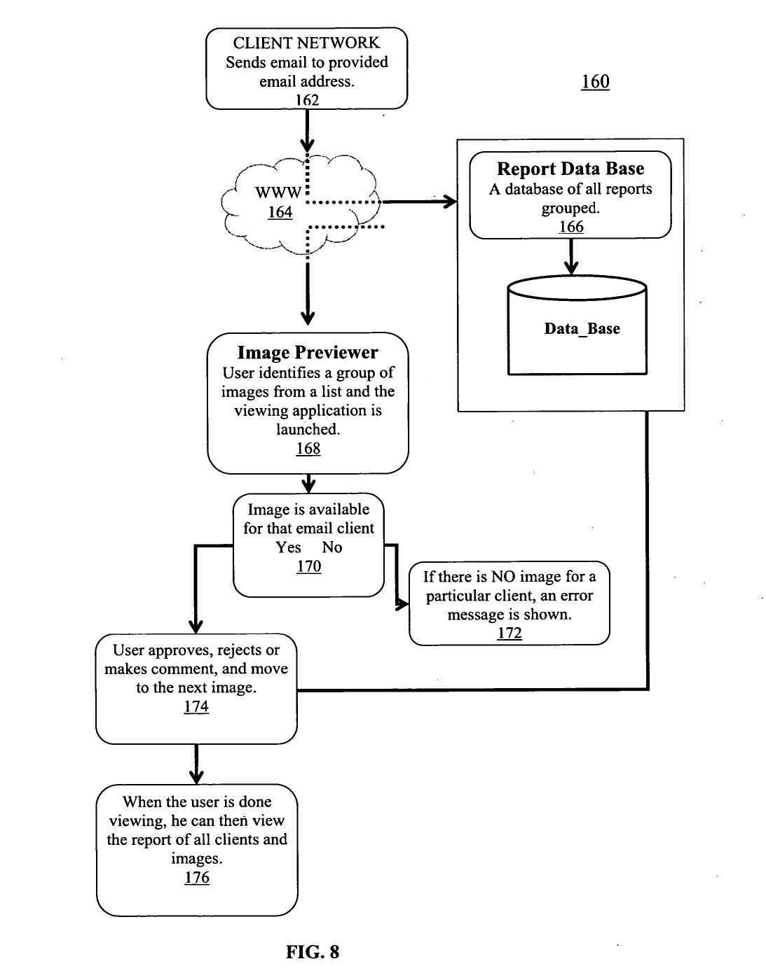

Referring to FIG. 8, reference 160 generally indicates a method, in accordance with the invention, to review images captured in response to a test email sent to a plurality of email clients. As shown at operation 162, a client machine (e.g. the client computer 56) may send a test email to an email address provided by the system 20. The test email may then be communicated via a network 164 to one or more test client machines. As described above, captured images may be provided in a report database 76 (see block 166). A user may then access the report database 76 which, in one exemplary embodiment, and data from the report database 76 may then be used by an application that generates the graphical user interface 130. Accordingly, the method 160 allows a user to access a plurality of captured images displayed by the plurality of email clients and provides a graphical user interface (e.g. the graphical user interface 130) to the user to allow the user to process the captured images. As shown at operation 168, the user may identify a group of images from a list of images (e.g. provided in the email client display area 132). In one exemplary embodiment, an image previewer application that generates the GUI 130 is automatically launched and displays a first image in the image display area 134 that corresponds to the first image listed in the email client d132. As shown at decision operation 170, if no image is available for a selected email client an error message may be shown (see operation 172). If, however, an image is available for the selected email client, a user may then approve, reject or make comment as described above (see also operation 174). As previously mentioned, when a user has reviewed one or more of the captured images, a report may be generated as shown at operation 176.

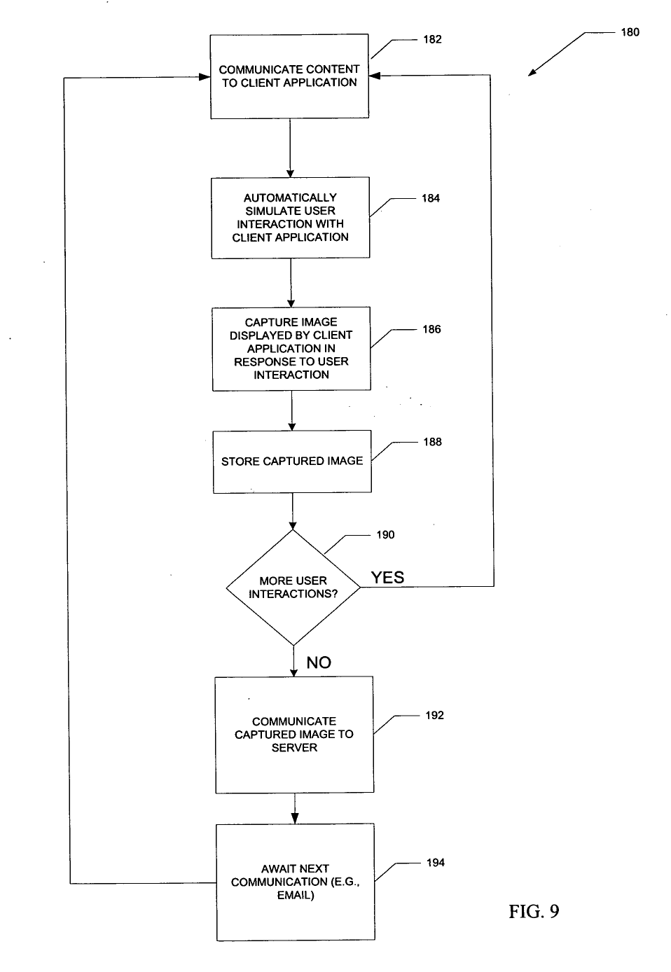

Referring to FIG. 9, reference 180 shows a further exemplary embodiment of a method, in accordance with an embodiment of the invention, to communicate content to a display client or application. It will be appreciated that the display client may be any display client or application running on a client device. In one exemplary embodiment, the method 180 communicates content using HTML via the Internet. As shown at operation 182, the method 180 may first communicate the content to the client application and, thereafter, user interaction with the client application is automatically simulated (see operation 184). The method 180 then captures any image for display by the client application in response to the user interaction (see block 186) and stores the captured image at operation 188. Thereafter, at decision operation 190, the method 180 determines if there are any further user interactions required and, if so, the method 180 returns to the operation 182 to automatically simulate further user interactions. If, however, no more user interactions are required, the method 180 proceeds to operation 192 where the stored images that have been captured are communicated to a central server (or any other computing device for review). The captured images may be communicated using FTP to the central server or any other appropriate computer. The method 180 then waits for any further communications as shown at operation 194. It will be appreciated that a captured image may be converted into any convenient format such as a JPEG format, BMP format, a TIFF format, or any other suitable format.

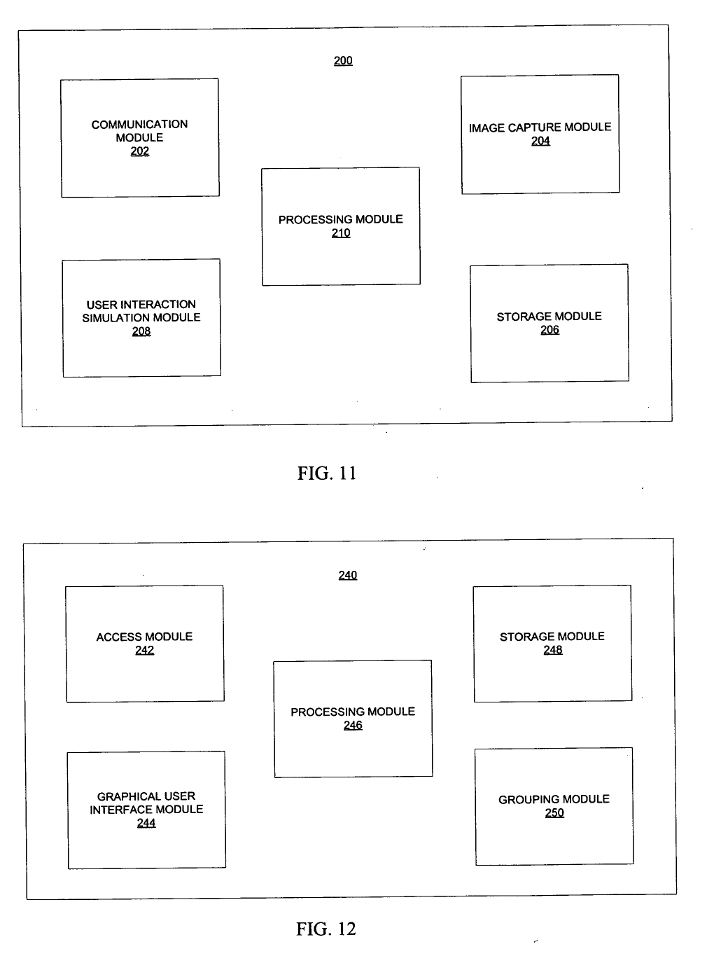

FIG. 11 shows an exemplary system 200 for reviewing the display of content by a plurality of different content display applications. The system 200 may include a communication module 202, an image capture module 204, a storage module 206, a user interaction simulation module 208, and a processing module 210. The exemplary modules 202 to 210 may perform the method 180 in one exemplary embodiment. It will also be appreciated that one or more of the modules 202-210 may be combined and one more modules may be omitted in different embodiments. Further, the modules 202-210 may reside on one or more computers. As mentioned above, the user interaction simulation module 208 may be in the form of a script running on a client machine. It will be appreciated that the user interaction module 208 may simulate any interaction by the user including, but not limited to mouse clicks to open an email, open a link in an email, scroll through an email, or any other action or functionality that a client application may provide to a user. In an embodiment, the user interactions module 208 may simulate may any single interaction or a sequence of user interactions with the display client. For example, the user interaction module 208 may simulate selection of a preview pane or any other views that the display application may allow a user to select. In this example, the user interaction module may simulate view or display setting selected by a user via a toolbar provided in the display client (e.g., a toolbar of an email client).

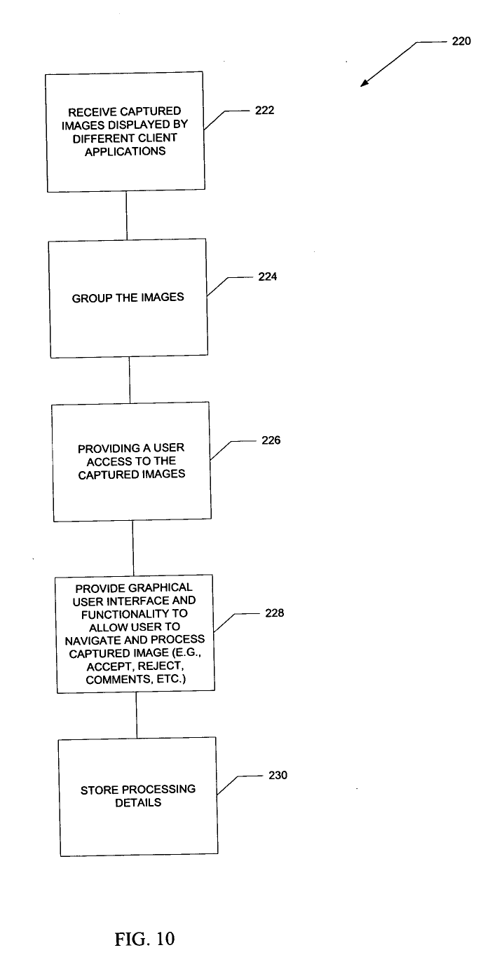

In FIG. 10, reference 220 generally indicates a method, in accordance with the invention, to review images captured in response to a communication sent to a plurality of display clients or client applications. As shown at operation 222, the method 220 receives captured images displayed in different client applications and, thereafter, may group or arrange the images in any convenient manner as shown at operation 224. In an embodiment, images from a single test email are arranged per client application from which they were captured.

A user may then be provided access to the captured images as shown at operation 226 (e.g., access to a particular website hosting the system) whereafter a graphical user interface is provided as well as functionality to allow the user to navigate and process each captured image (see operation 228). The graphical user interface provided may resemble the graphical user interface 130. However, the graphical interface provided by the method 220 need not necessarily be restricted to content communicated via email. Once a user has processed the captured images, processing details may be stored as shown at operation 230.

FIG. 12 shows an exemplary system 240 which may, in an embodiment, perform the method 180. The system 240 is shown by way of example to include an access module 242 to allow a user to access captured images, a graphical user interface module 244 to allow a user to process the captured images in conjunction with a processing module 246. A storage module 248 is provided to store processing data and a grouping module 250 may allow a user to group captured images in a preferred configuration or arrangement.

It is to be appreciated that any of the methodologies, modules or systems describes herein may be combined or function in a distributed fashion. For example, a single computer may be used to generate the content, generate images as would be displayed by a plurality of different display clients (e.g., email clients) and then allow review of the captured images.

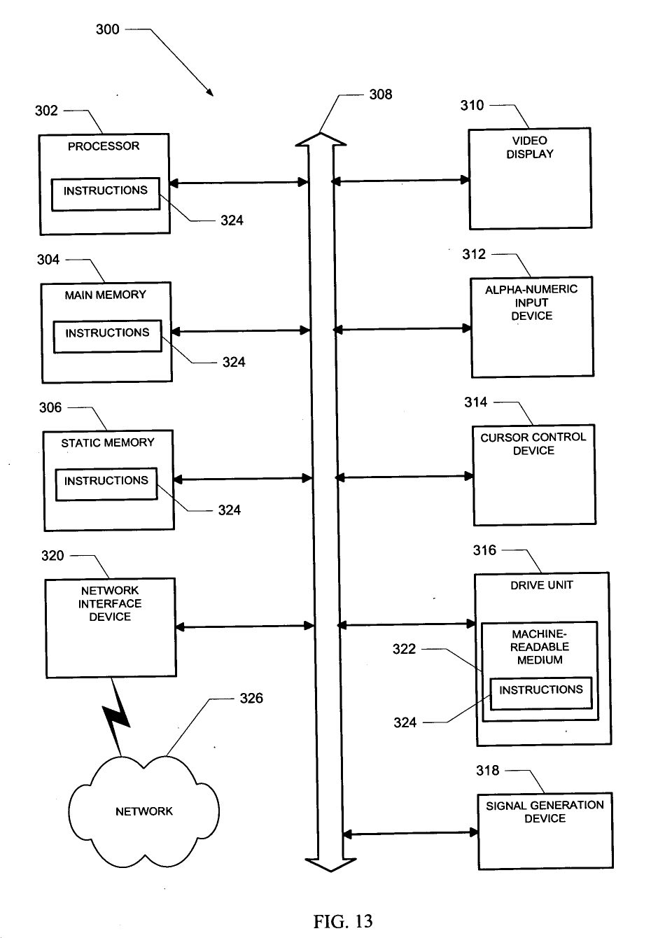

FIG. 13 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to review the display of content by at least one display client have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to review the display of content by at least one client application, the method comprising:
communicating content to the at least one client application;
automatically simulating at least one user interaction with the at least one client application in response to receiving the content;
capturing an image displayed by the client application in response to the at least one user interaction; and
storing the captured image.

2. The method of claim 1, wherein client application includes at least one email client and the method includes communicating the content in an email.

3. The method of claim 2, wherein the image is captured after each simulated user interaction, the captured image corresponding to a screen display viewable by a computer system running the at least one email client.

4. The method of claim 2, wherein the email is a test email to review the display of content of the test email prior to bulk mailing the email to a plurality of users via the Internet.

5. The method of claim 2, which comprises communicating the email to a plurality of email clients to review how each email client would display the content of the email.

6. The method of claim 5, wherein the plurality of email clients are selected from the group including Microsoft Outlook, Lotus Notes, Yahoo mail, MSN Hotmail, AOL mail, and Eudora.

7. The method of claim 5, which comprises running each email client on a different client machine.

8. The method of claim 1, which comprises automatically taking a screen shot to obtain the captured image.

9. The method of claim 2, which comprises:
automatically simulating a plurality of user interactions;
capturing an image displayed after each simulated user interaction to provide a plurality of captured images generated from the email;
communicating the plurality of captured images to a central server; and
providing access to the plurality of captured images to a sender of the email.

10. The method of claim 9, which includes using FTP to communicate the captured image to the central server.

11. The method of claim 9, which comprises grouping images captured from different email clients in response to the email to facilitate review thereof by a sender of the email.

12. The method of claim 1, which comprises running a script on a client machine running the client application to simulate the at least one user interaction.

13. The method of claim 1, wherein the content is an advertisement for bulk communication via the Internet.

14. A machine-readable medium embodying instructions which, when executed by a machine, cause the machine to perform the method of claim 1.

15. A method of reviewing content sent to a plurality of client applications, the method comprising:
accessing a plurality of captured images displayed by the plurality of client applications;
providing a graphical user interface that renders:
a client application display area to list the plurality of client applications from which the plurality of captured images were captured;
a captured image display area to display captured images sourced from each client application; and
navigation buttons to allow a user to navigate through the captured images;
monitoring activation of the navigation buttons;
selectively rendering a metadata entry area to allow a user to enter metadata associated with a captured image displayed in the captured image display area; and
storing the metadata entered by the user, the metadata being associated with the displayed captured image.

16. The method of claim 15, wherein the client application is an email client and the content is communicated via an email.

17. The method of claim 16, wherein the graphical user interface comprises an accept button to accept a captured image and tag the image as accepted, and a reject button to reject a captured image and tag the image as rejected.

18. The method of claim 15, which includes generating report based on the user interaction.

19. A machine-readable medium embodying instructions which, when executed by a machine, cause the machine to perform the method of claim 15.

20. A system to review the display of content by at least one client application, the system comprising:
a communication module to communicate the content to the at least one client application;
a simulation module to automatically simulate at least one user interaction with the at least one client application in response to receiving the content;
an image capture module to capture an image displayed by the client application in response to the at least one user interaction; and
a storage module to store the captured image.

21. The system of claim 20, wherein the image is captured after each simulated user interaction, the captured image corresponding to a screen display viewable by a computer system running the at least one client application.

22. The system of claim 20, wherein the email is a test email to review the display of content of the test email prior to bulk mailing the email to a plurality of users via the Internet.

23. The system of claim 20, which comprises a plurality of email clients to which the email is communicated to review how each email client would display the content.

24. A system to review images captured from a plurality of client applications, the system comprising:
an access module to access a plurality of captured images displayed by the plurality of client applications;
a graphical user interface module to provide a graphical user interface that renders:
a client display area to list the plurality of client applications from which the plurality of captured images were captured;
a captured image display area to display captured images sourced from each client application; and
navigation buttons to allow a user to navigate through the captured images;
a monitoring module to monitor activation of the navigation buttons,
wherein the graphical user interface selectively renders a metadata entry area to allow a user to enter metadata associated with a captured image displayed in the captured image display area; and
a storage module to store the metadata entered by the user, the metadata being associated with the displayed captured image.

25. The system of claim 24, which wherein:
the simulation module automatically simulates a plurality of user interactions;
the capturing module captures an image displayed after each simulated user interaction to provide a plurality of captured images generated from the content;
the communication module communicates the plurality of captured images to a server; and
the access module provides access to the plurality of captured images to a sender of the content.

26. A system to review the display of content by at least one client application, the system comprising:
means for communicating content to the at least one client application;
means for automatically simulating at least one user interaction with the at least one client application in response to receiving the content;
means for capturing an image displayed by the client application in response to the at least one user interaction; and
means for storing the captured image.
